(19) United States
(12) Patent Application Publication
(10) Pub. No.: US 2021/0083444 A1
(43) Pub. Date: Mar. 18, 2021

(54) Crimping Tool

(71) Applicant: Hanlong Industrial Co., Ltd., New Taipei City (TW)

(72) Inventor: Mei-Fang Lin, New Taipei City (TW)

(21) Appl. No.: 16/727,200

(22) Filed: Dec. 26, 2019

(30) Foreign Application Priority Data
Sep. 12, 2019 (TW) 108212188

(51) Int. Cl. H01R 43/042; B25B 27/14; B25B 7/04; B25B 7/22

(52) U.S. Cl. CPC H01R 43/0421; B25B 7/22; B25B 7/04; B25B 27/146

(57) ABSTRACT

The crimping tool is disclosed. The crimping tool includes a pair of pliers and a pair of jaws. Each plier includes a headend and a grip end. Each headend includes a first accommodating groove and a first engaging member, where the first engaging member is located on one side of the first accommodating groove. Each grip end includes a second accommodating groove and a second engaging member, where the second engaging member is located on one side of the second accommodating groove. The jaws are detachably mounted to the first accommodating groove or the second accommodating groove of the grip end, and each of the jaws has a junction. When each jaw is mounted to the first accommodating groove or the second accommodating groove, each junction substantially corresponds to the first engaging member or the second engaging member to engage each jaw.

### BACKGROUND OF THE INVENTION

### 1. Field of the Invention

The present invention relates to a crimping tool, particularly to a crimping tool having space to accommodate jaws easily.

### 2. Description of the Related Art

Since the terminal crimping tools connected at one end of a wire are diversified, the shape of the crimping interface of the hand tool used to crimp the two objects must be different according to the different shape of the terminal crimping tool. Therefore, the design of jaws of the crimping tool currently on the market can be replaced by users according to their needs. However, after the jaws are replaced, there is no convenient storage space, so the replaced jaws are easy to lose.

Accordingly, it is necessary to invent a new crimping tool to mitigate and/or obviate the aforementioned problems.

### SUMMARY OF THE INVENTION

It is a major objective of the present invention to provide a crimping tool having space to accommodate jaws easily.

To achieve the above objective, a crimping tool of the present invention includes a pair of pliers and a pair of jaws. Each of the pliers includes a headend and a grip end. Each headend of the pliers includes a first accommodating groove and a first engaging member, where the first engaging member is located on one side of the first accommodating groove. The grip end is connected to the headend. Each grip end of the pliers includes a second accommodating groove and a second engaging member, where the second engaging member is located on one side of the second accommodating groove. The jaws are detachably mounted to the first accommodating groove or the second accommodating groove of the grip end, and each of the jaws has a junction. When each of the jaws is mounted to the first accommodating groove of the headend or the second accommodating groove of the grip end, each of the junction substantially corresponds to the first engaging member or the second engaging member to engage each of the jaws.

The other crimping tool in the present includes a pair of pliers and a pair of jaws. Each of the pliers includes a headend and a grip end. The grip end is connected to the headend. Each grip end of the pliers includes an accommodating groove and an engaging member, where the engaging member is located on one side of the accommodating groove. The jaws are detachably mounted to the accommodating groove of each grip end, and each of the jaws has a junction. When each of the jaws is mounted to the accommodating groove of each grip end, each of the junction essentially corresponds to the engaging member to engage each of the jaws.

### BRIEF DESCRIPTION OF THE DRAWINGS

FIG. 1 is a schematic view showing the appearance of a crimping tool in the present invention;

FIG. 1A is a schematic cross-sectional view showing the crimping tool of the present invention along the A-A direction of FIG. 1;

FIG. 1B is a schematic cross-sectional view showing the crimping tool of the present invention along the B-B direction of FIG. 1;

FIG. 1C is a schematic cross-sectional view showing the crimping tool of the present invention along the C-C direction of FIG. 1;

FIG. 2 is a schematic view showing jaws mounted onto a headend of the crimping tool of a first embodiment of the present invention;

FIG. 3 is a schematic view showing jaws mounted onto a grip end of the crimping tool of the first embodiment of the present invention;

FIGS. 4A-4B are schematic cross-sectional views showing the jaws mounted onto the grip end of the crimping tool of the first embodiment of the present invention;

FIG. 5 is a schematic view showing the jaws mounted onto the headend of the crimping tool of a second embodiment of the present invention;

FIG. 6 is a schematic view showing the jaws mounted onto the grip end of the crimping tool of the second embodiment of the present invention;

FIG. 7 is a schematic cross-sectional view showing the jaws mounted onto the rear end of the grip end of the crimping tool of the second embodiment of the present invention;

FIG. 8A-8B are schematic cross-sectional views showing the jaws mounted onto the front end of the grip end of the crimping tool of the second embodiment of the present invention; and

FIG. 9 is a schematic view showing the appearance after the jaws mounted onto the grip end of the crimping tool in the present invention.

### DETAILED DESCRIPTION OF THE PREFERRED EMBODIMENT

Hereafter, the technical content of the present invention will be better understood with reference to preferred embodiments.

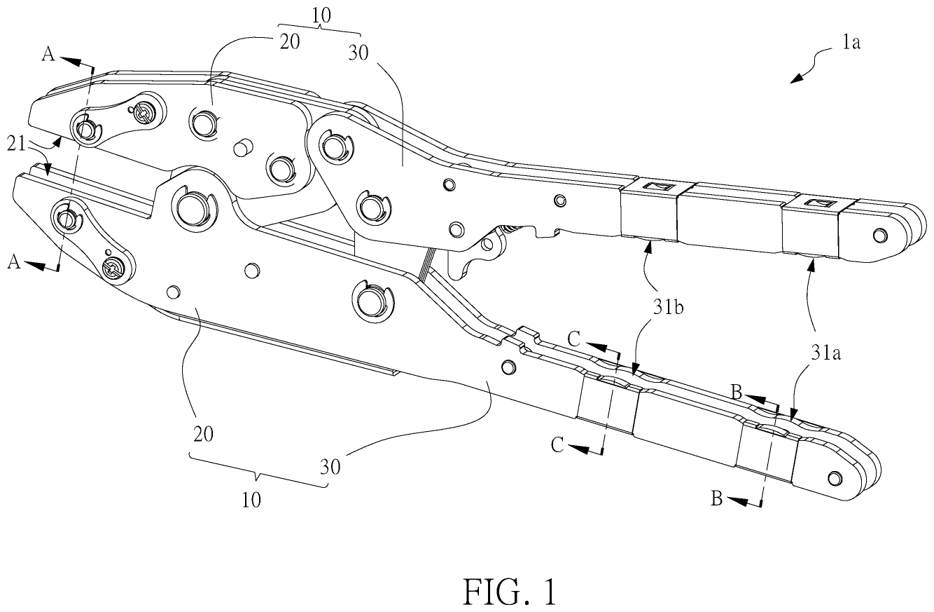

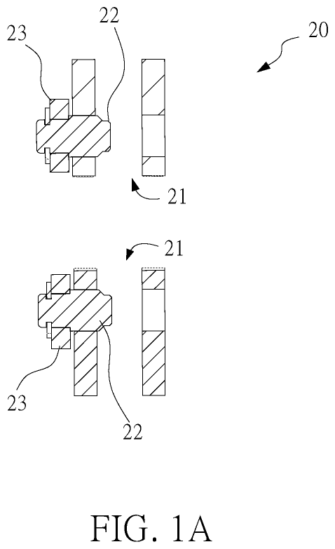

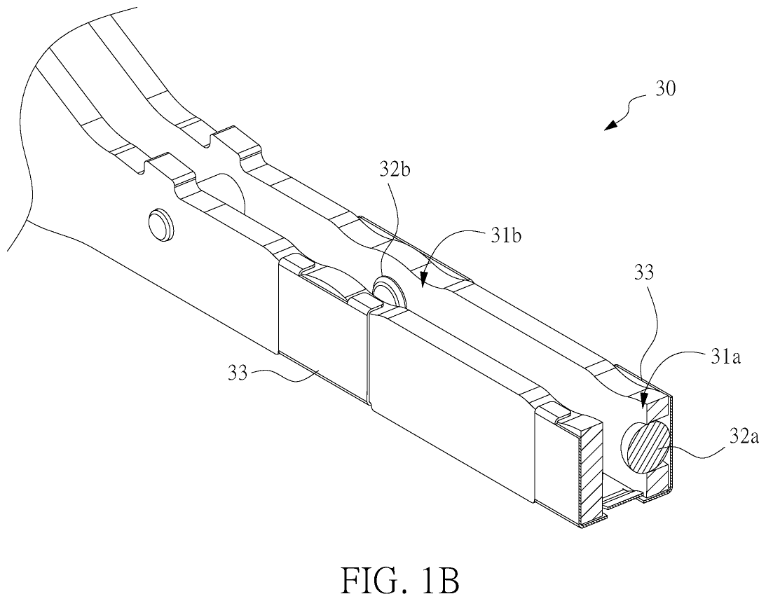

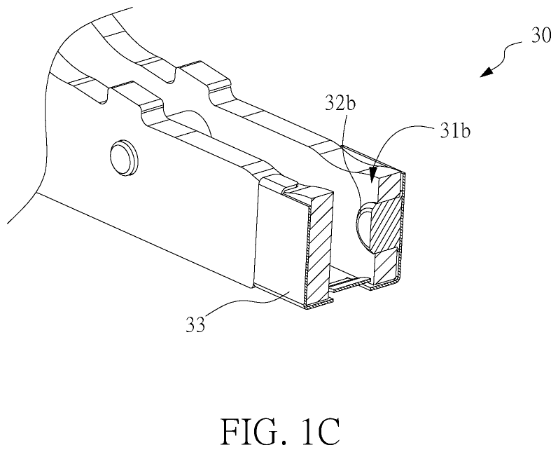

Hereafter, please first refer to FIG. 1 for a schematic view showing the appearance of a crimping tool in the present invention. It should be noted that although the following description uses the terms such as “first” and “second” to describe various elements, these elements should not be limited by these terms. For example, without departing from the scope of the various described embodiments, a first accommodating groove may be referred to as a second accommodating groove, and similarly, a second accommodating groove may be referred to as a first accommodating groove. Both the first accommodating groove and the second accommodating groove are accommodating grooves, but they are not the same accommodating groove.

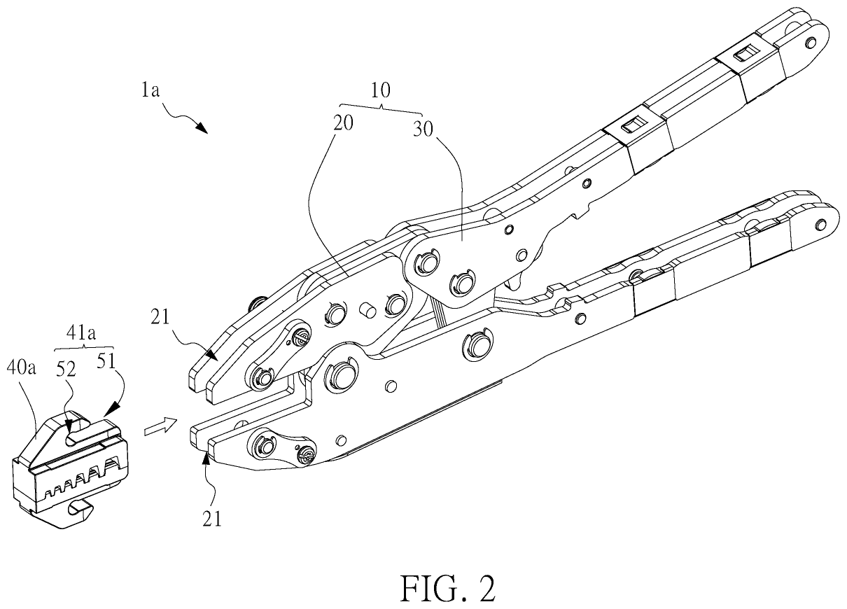

A crimping tool 1a of the present invention may include a pair of pliers 10 and a pair of jaws 40a mountable to the pliers 10 (as shown in FIG. 2). Each of the pliers 10 includes a headend 20 and a grip end 30. The headend 20 is connected to the grip end 30. Also, the headend 20 includes a first accommodating groove 21, and the grip end 30 includes a second accommodating groove 31a, 31b. Specifically, the second accommodating groove 31a, 31b can be one after the other, but the present invention can adjust the number of accommodating grooves according to the size of the grip end 30 and the jaws 40a, and the number in the present invention is not limited to two.

Then, please refer to FIG. 1A for a schematic cross-sectional view of the crimping tool of the present invention along the A-A direction of FIG. 1.

As can be seen from FIG. 1A, a first engaging member 22 and a fixing element 23 are provided on one side of the first accommodating groove 21 of the headend 20. The first engaging member 22 can pass through a hole on the side of the first accommodating groove 21 and extend to the inside of the first accommodating groove 21, and finally is fixed by the fixing element 23 on the outside of the first accommodating groove 21. The fixing element 23 can be a screw or a combination of a bolt and a connecting rod, but the present invention does not limit the design of the fixing element 23.

Then, please refer to FIG. 1B and FIG. 1C. Specifically, FIG. 1B is a schematic cross-sectional view of the crimping tool of the present invention along the B-B direction of FIG. 1, and FIG. 1C is a schematic cross-sectional view of the crimping tool of the present invention along the C-C direction of FIG. 1.

The second accommodating groove 31a and the second accommodating groove 31b on the grip end 30 of the pliers 10 may each have a second engaging member 32a and a second engaging member 32b having different shapes. Specifically, the second engaging member 32a is a spherical, and the second engaging member 32b is a convex pillar, but the present invention is not limited thereto. The second engaging member 32a and the second engaging member 32b can both pass through the hole on one side of the second accommodating groove 31a and the second accommodating groove 31b, and extend to the inside of the second accommodating groove 31a and the second accommodating groove 31b. Moreover, the outside of the second accommodating groove 31a and the second accommodating groove 31b is provided with a U-shaped iron elastic member 33. The elastic member 33 can be wrapped around the second engaging member 32a and the second engaging member 32b, such that when the second engaging member 32a and the second engaging member 32b are pressed, the elasticity of the elastic member 33 can be provided. However, the elastic member 33 of the present invention is not limited to the shape shown in FIG. 1B and FIG. 1C.

Then, please refer to FIG. 2, which is a schematic view showing the jaws mounted onto a headend of the crimping tool of a first embodiment of the present invention.

In the first embodiment of the present invention, the jaw 40a includes a junction 41a. The junction 41a is U-shaped and can be divided into an opening 51 and an end portion 52. The width of the opening 51 and the end portion 52 corresponds to that of first engaging member 22. Accordingly, when the jaws 40a are to be mounted to the first accommodating groove 21, the first engaging member 22 can be slid from the opening 51 of the junction 41a to the end portion 52 of the junction 41a. Then the first engaging member 22 and junction 41a can be fixed by the fixing element 23. In this way, the jaws 40a are not easy to shake arbitrarily.

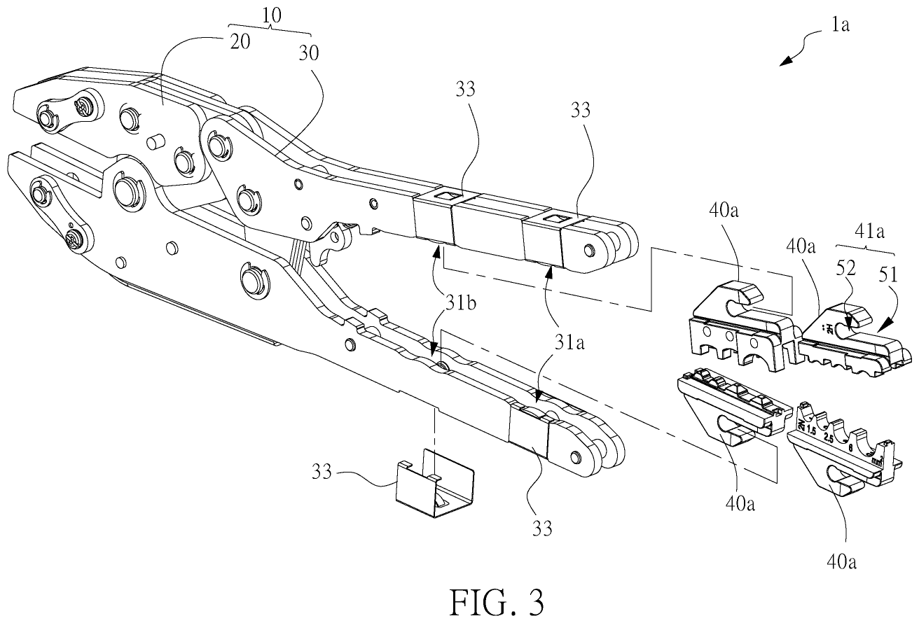

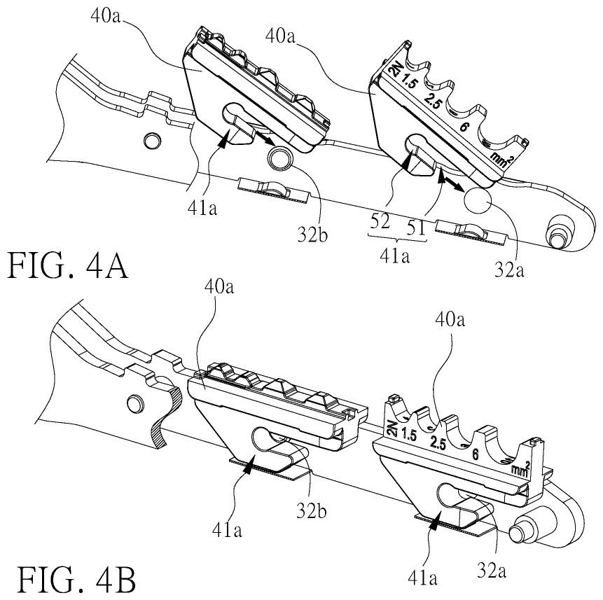

Then, please refer to FIGS. 3 to 4B. Specifically, FIG. 3 is a schematic view showing jaws mounted onto a grip end of the crimping tool of the first embodiment of the present invention, and FIGS. 4A-4B are schematic cross-sectional views showing the jaws mounted onto the grip end of the crimping tool of the first embodiment of the present invention.

The width of the opening 51 and the end portion 52 also corresponds to that of the second engaging member 32a and the second engaging member 32b. When the jaws 40a are to be placed onto the second accommodating groove 31a or the second accommodating groove 31b, the jaws 40a are inserted after tilted, such that the second engaging member 32a or the second engaging member 32b is moved from the opening 51 of the junction 41a to the end portion 52 of the junction 41a. The end portion 52 of the junction 41a can be engaged with the second engaging member 32a or the second engaging member 32b. In this way, the jaws 40a will not shake arbitrarily.

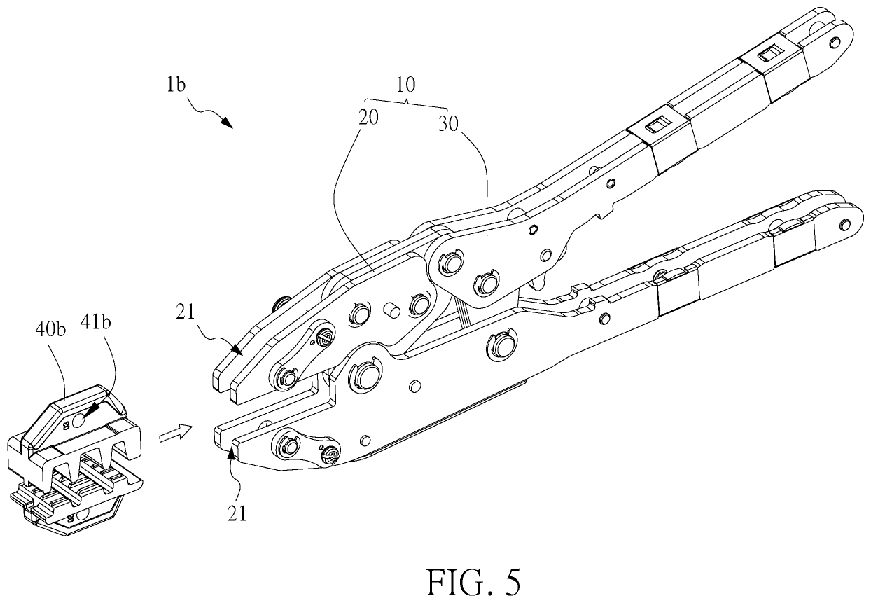

Then, please refer to FIG. 5, which is a schematic view showing the jaws mounted onto the headend of the crimping tool of a second embodiment of the present invention.

In the second embodiment of the present invention, the shape of the junction 41b of the jaw 40b is different from that of the first embodiment. The junction 41b is a hole, and its width corresponds to that of the first engaging member 22. When the jaws 40b are mounted to the first accommodating groove 21, the junction 41b can be engaged with the first engaging member 22, and the first engaging member 22 and the junction 41b can be fixed by the fixing element 23. In this way, the jaws 40b are not easy to shake arbitrarily.

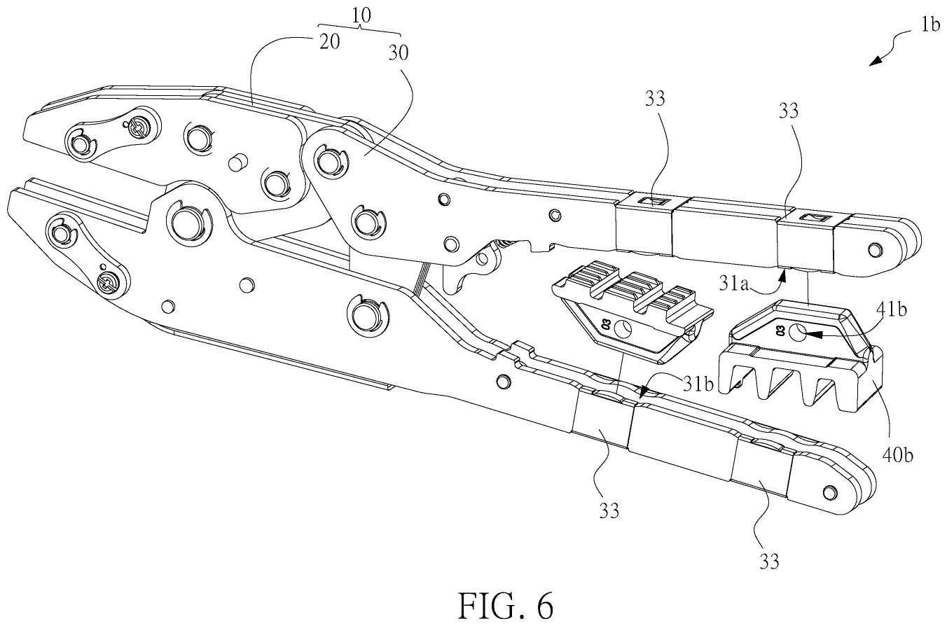

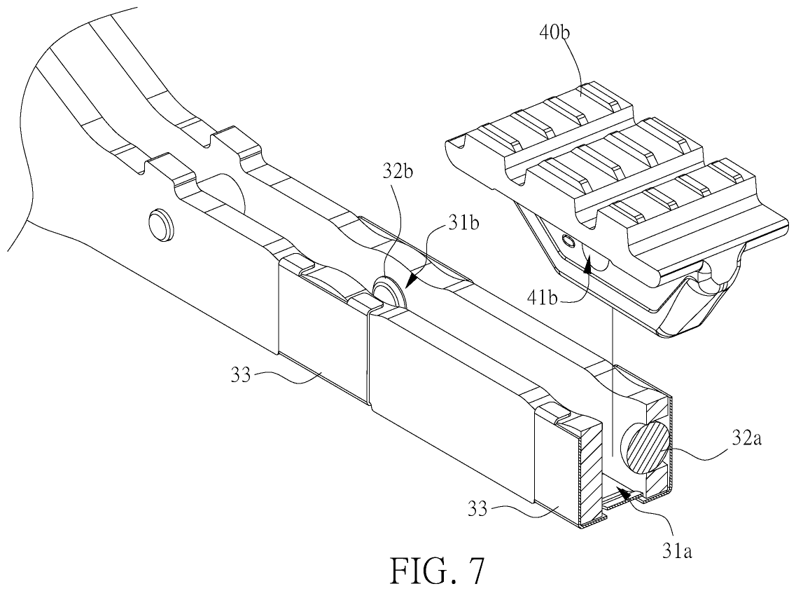

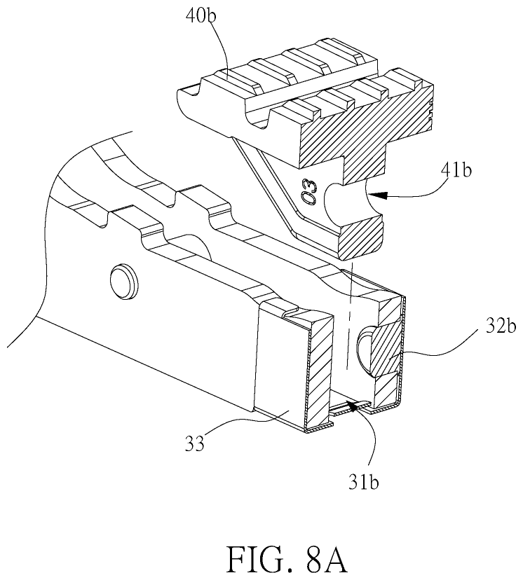

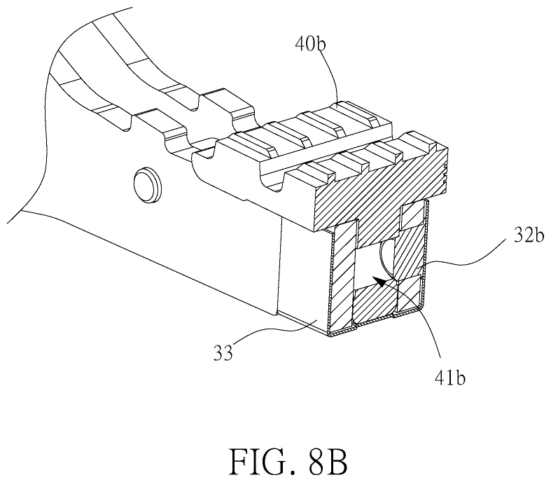

Finally, please refer to FIGS. 6 to 8B. FIG. 6 is a schematic view showing the jaws mounted onto the grip end of the crimping tool of the second embodiment of the present invention; FIG. 7 is a schematic cross-sectional view showing the jaws mounted onto the rear end of the grip end of the crimping tool of the second embodiment of the present invention; and FIG. 8A-8B are schematic cross-sectional views showing the jaws mounted onto the front end of the grip end of the crimping tool of the second embodiment of the present invention.

The width of the junction 41b corresponds to that of the second engaging member 32a and the second engaging member 32b. When the jaws 40b are placed on the second accommodating groove 31a on the back end or the second accommodating groove 31b on the front end, the jaws 40b can be inserted vertically into the grip end 30, such that the junction 41b and the second engaging member 32a or the second engaging member 32b can be engaged with each other, as the continuous action shown in FIGS. 8A-8B.

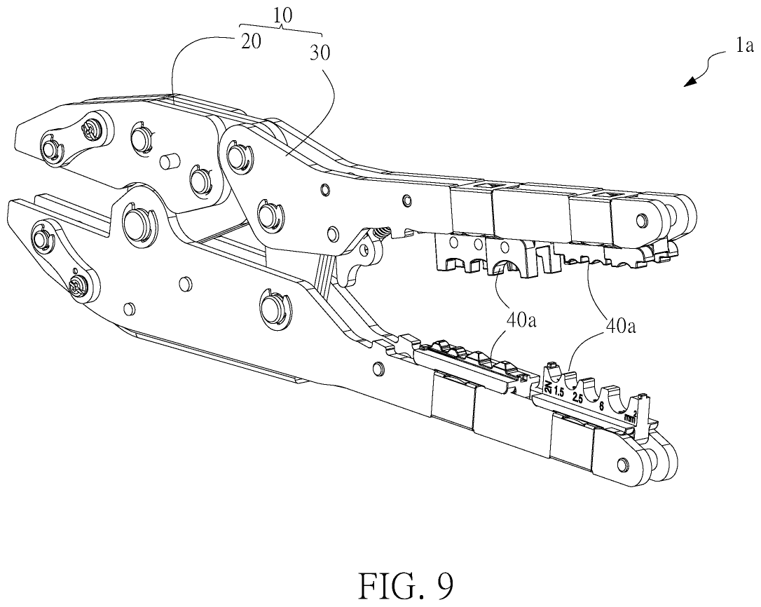

Lastly, refer to FIG. 9, which is a schematic view showing the appearance of the jaws of the present invention after being mounted to the grip end of the crimping tool.

Finally, with the aforementioned crimping tool 1a or 1b, the jaws 40a or jaws 40b can be mounted onto a pair of grip ends 30 for easy storage of the spare jaws 40a or jaws 40b. In FIG. 9, for example, four jaws 40a are placed onto the grip end 30 of the crimping tool 1a, but the present invention is not limited thereto.

Additionally, the preferred embodiments of the present invention described above are merely illustrative. To avoid redundancy, all the possible combinations of changes are not documented in detail. However, it shall be understood by those skilled in the art that each of the modules or elements described above may not be necessary. For the implementation of the present invention, the present invention may also contain other detailed, conventional modules or elements. Each module or component is likely to be omitted or modified depending on the needs. Other modules or elements may not necessarily exist between two of any modules. All without departing from the scope of the invention are defined solely by the appended claims.

What is claimed is:

1. A crimping tool, comprising:
a pair of pliers, each comprising:
a headend, each comprising a first accommodating groove and a first engaging member, wherein the first engaging member is located on one side of the first accommodating groove; and
a grip end, connected to the headend, each said grip end of the pliers comprising a second accommodating groove and a second engaging member, wherein the second engaging member is located on one side of the second accommodating groove; and
a pair of jaws, detachably mounted to the first accommodating groove of the headend or the second accommodating groove of the grip end, wherein each of the jaws has a junction, and when each of the jaws is mounted to the first accommodating groove of the headend or the second accommodating groove of the grip end, each said junction substantially corresponds to each of the first engaging member or the second engaging member to be engaged with each of the jaws.

2. The crimping tool as claimed in claim 1, wherein the grip end further comprising a pair of elastic members, which are in contact with the pair of second engaging members and provide an elastic force to enable the second engaging member to be engaged with the junction of each of the jaws.

3. The crimping tool as claimed in claim 2, wherein the elastic member is a U-shaped iron piece.

4. The crimping tool as claimed in claim 1, wherein the second engaging member is a convex pillar.

5. The crimping tool as claimed in claim 1, wherein the engaging member is a spherical.

6. The crimping tool as claimed in claim 1, wherein the junction of the jaws is a hole.

7. The crimping tool as claimed in claim 1, wherein the junction of the jaws includes an opening and an end portion.

8. The crimping tool as claimed in claim 1, wherein the headend further comprising a pair of fixing elements that can be mounted to the first accommodating groove to fix the junction.

9. A pair of pliers, each comprising:
a headend; and
a grip end, which is connected to the headend, each said grip end of the pliers comprising an accommodating groove and an engaging member, wherein the engaging member is located at one side of the accommodating groove; and
a pair of jaws, detachably mounted to the accommodating groove of the grip end, wherein each of the jaws has a junction, and when each of the jaws is mounted to the accommodating groove of the grip end, each of the junctions substantially corresponds to the engaging member to be engaged with the pair of jaws.

10. The crimping tool as claimed in claim 9, wherein the grip end further comprising a pair of elastic members, which are in contact with the pair of engaging members and provide an elastic force to enable the engaging member to be engaged with the junction of each of the jaws.

11. The crimping tool as claimed in claim 10, wherein the elastic member is a U-shaped iron piece.

12. The crimping tool as claimed in claim 9, wherein the engaging member is a convex pillar.

13. The crimping tool as claimed in claim 9, wherein the engaging member is a spherical.

14. The crimping tool as claimed in claim 9, wherein the junction of the jaws is a hole.

15. The crimping tool as claimed in claim 9, wherein the junction of the jaws includes an opening and an end portion.
